(19) United States
(12) Patent Application Publication
(10) Pub. No.: US 2023/0276484 A1
(43) Pub. Date: Aug. 31, 2023

(54) MEASUREMENTS AND OPERATIONS BASED ON DIFFERENT TYPES OF SYNCHRONIZATION SIGNAL BLOCKS

(71) Applicant: QUALCOMM Incorporated, San Diego, CA (US)

(72) Inventors: Jing LEI, San Diego, CA (US); Muhammad Nazmul ISLAM, Littleton, MA (US); Chun-Hao HSU, San Jose, CA (US); Linhai HE, San Diego, CA (US); Carsten Aagaard PEDERSEN, Bolton, MA (US); Murali MENON, Acton, MA (US)

(21) Appl. No.: 18/173,018

(22) Filed: Feb. 22, 2023

Related U.S. Application Data
(60) Provisional application No. 63/314,263, filed on Feb. 25, 2022.

(51) Int. Cl. H04W 72/542

(52) U.S. Cl. CPC H04W 72/542

(57) ABSTRACT

The aspects described herein are directed to measurement and reporting procedures of an apparatus (e.g., a low-tier user-equipment (UE) or a regular UE) when a bandwidth part (BWP) of the apparatus includes one or both of a first type of synchronization signal block (SSB) (e.g., a cell-defining (CD-SSB)) and second type of SSB (e.g., a non-cell-defining SSB (NCD-SSB)). The apparatus measures at least one of the first type of SSB that is periodically transmitted to a first group of UEs, a second type of SSB that is periodically transmitted within a time window to a second group of UEs, or both the first type of SSB and the second type of SSB for an operation based on a configuration of the operation, and performs the operation based on a measurement of at least one of the first type of SSB, the second type of SSB, or a combination thereof.

### CROSS REFERENCE TO RELATED APPLICATION

This application claims priority to and the benefit of U.S. Provisional Application No. 63/314,263, entitled “MEASUREMENTS AND OPERATIONS BASED ON DIFFERENT TYPES OF SYNCHRONIZATION SIGNAL BLOCKS” and filed in the U.S. Patent Office on Feb. 25, 2022, the entire content of which is incorporated herein by reference as if fully set forth below in its entirety and for all applicable purposes.

### BACKGROUND

### Technical Field

The present disclosure relates generally to communication systems, and more particularly, to measurements and operations at a user equipment (UE) based on different types of synchronization signal blocks (SSBs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The aspects described herein are directed to measurement and reporting operations (also referred to as measurement and reporting procedures) of low-tier user-equipments (UEs) and regular UEs when a downlink (DL) bandwidth part (BWP) of a low-tier UE or regular UE includes different types of synchronization signal blocks (SSBs). For example, a DL BWP of a UE may include one or both of a cell-defining synchronization signal block (CD-SSB) and a non-cell-defining SSB (NCD-SSB).

In an aspect of the disclosure, a method, a computer-readable medium, and an apparatus are provided. The apparatus may be a UE. The UE may measure at least one of a first type of SSB that is periodically transmitted to a first group of UEs, a second type of SSB that is periodically transmitted within a time window to a second group of UEs, or both the first type of SSB and the second type of SSB for an operation based on a configuration of the operation and may perform the operation based on a measurement of at least one of the first type of SSB, the second type of SSB, or a combination thereof.

In an aspect of the disclosure, a method, a computer-readable medium, and an apparatus are provided. The apparatus may be a base station. The base station transmits at least one of a first type of SSB periodically to a first group of UEs, a second type of SSB periodically within a time window to a second group of UEs, or both the first type of SSB and the second type of SSB and receives a message associated with an operation of a UE based on a measurement of at least one of the first type of SSB, the second type of SSB, or a combination thereof.

In some aspects, the first type of SSB is a CD-SSB and the second type of SSB is a NCD-SSB, wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

In some aspects, the apparatus transmits a configuration of the operation indicating to use the first type of SSB, the second type of SSB, or both the first type of SSB and the second type of SSB for the operation.

In some aspects, the message includes a measurement report containing a difference between a first signal strength of the first type of SSB and a second signal strength of the second type of SSB.

In some aspects, the first type of SSB and the second type of SSB are transmitted in a same bandwidth part of the UE.

In some aspects, the first group of UEs includes one or more UEs of a first type, and wherein the second group of UEs includes one or more UEs of a second type, wherein the one or more UEs of the second type have reduced capabilities relative to the one or more UEs of the first type.

In some aspects, a first transmit power of the first type of SSB is different from a second transmit power of the second type of SSB.

In some aspects, a first SSB symbol repetition pattern of the first type of SSB is different from a second SSB symbol repetition pattern of the second type of SSB.

In some aspects, a first SSB to network access occasion association pattern of the first type of SSB is different from a second SSB to network access occasion association pattern of the second type of SSB, and wherein a first SSB to network access occasion association periodicity of the first type of SSB is different from a second SSB to network access occasion association periodicity of the second type of SSB.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 illustrates example bandwidth parts of a carrier bandwidth in accordance with various aspects of the disclosure.

FIG. 5 illustrates a bandwidth part activation timing diagram for the first, second, and third bandwidth parts described with reference to FIG. 4.

FIG. 6 is a signal flow diagram in accordance with various aspects of the disclosure.

FIG. 7 is a flowchart of a method of wireless communication.

FIG. 8 is a flowchart of a method of wireless communication.

FIG. 9 is a conceptual data flow diagram illustrating the data flow between different means/components in an example apparatus.

FIG. 10 is a diagram illustrating an example of a hardware implementation for an apparatus employing a processing system.

FIG. 11 is a flowchart of a method of wireless communication.

FIG. 12 is a flowchart of a method of wireless communication.

FIG. 13 is a conceptual data flow diagram illustrating the data flow between different means/components in an example apparatus.

FIG. 14 is a diagram illustrating an example of a hardware implementation for an apparatus employing a processing system.

FIG. 15 shows a diagram illustrating an example disaggregated base station architecture according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

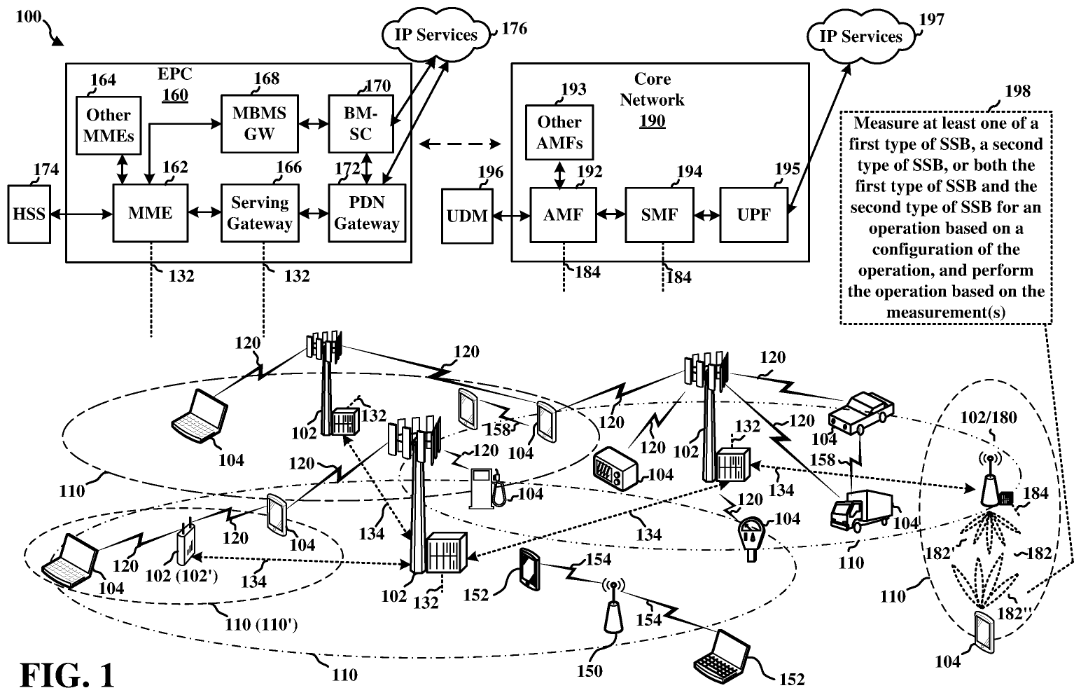

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to measure at least one of a first type of synchronization signal block (SSB), a second type of SSB, or both the first type of SSB and the second type of SSB for an operation based on a configuration of the operation, and may perform the operation based on the measurement(s) (198). Although the following description may be focused on 5G NR, the concepts described herein may be applicable to other similar areas, such as LTE, LTE-A, CDMA, GSM, and other wireless technologies.

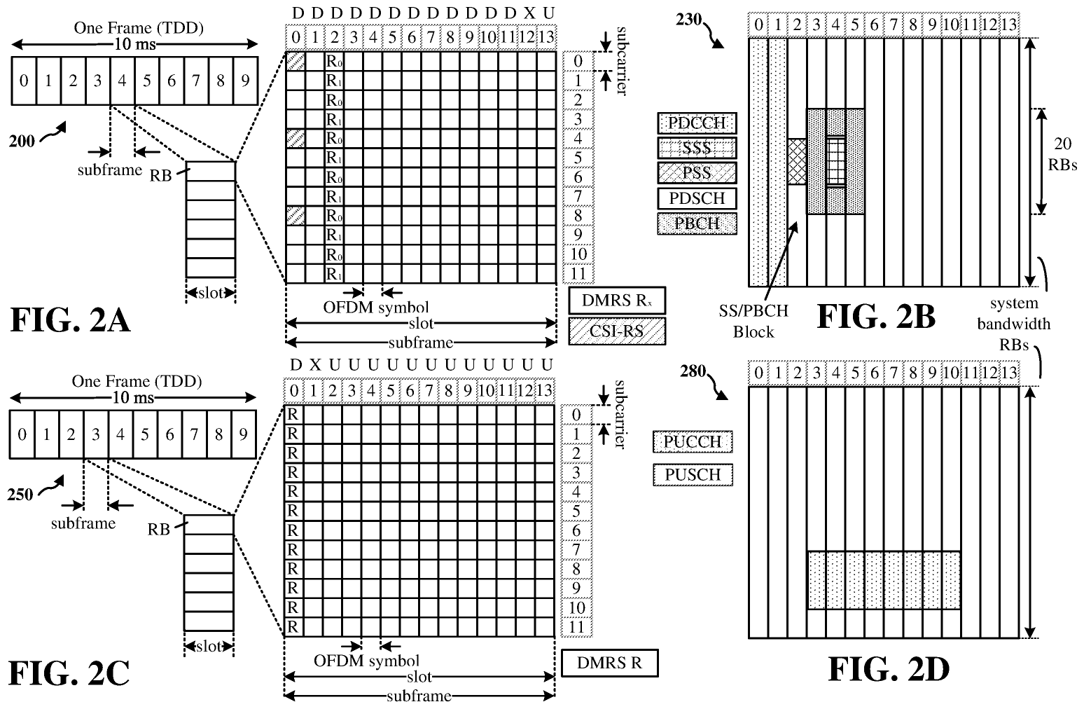

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ. 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as a synchronization signal block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

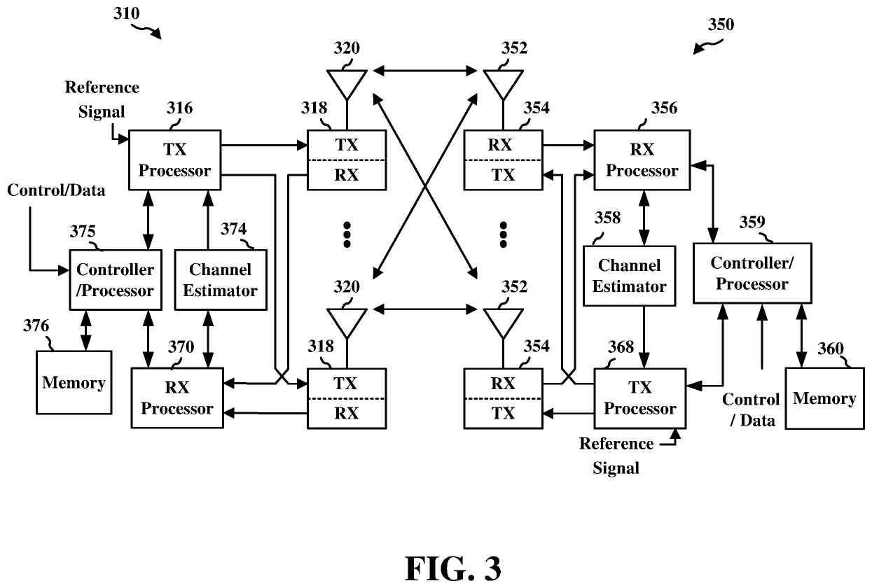

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

A cell-defining SSB (CD-SSB) may include four consecutive symbols and may include the PSS, the SSS, and the PBCH. The PBCH in the CD-SSB may include scheduling information for system information block 1 (SIB1). In some examples, SIB1 (also referred to as remaining minimum system information (RMSI)) may include information that a UE requires to gain initial access to the network (e.g., a base station, TRP, etc.), such as cell selection parameters related to the current cell, general access control parameters, configuration parameters of the common physical channel related to the initial access process, etc.

The CD-SSB may be transmitted periodically and may be “always-on.” In some examples, the period of the CD-SSB may be 20 ms (e.g., the CD-SSB may be repeated every 20 ms). Each periodic transmission of the CD-SSB may include multiple consecutive CD-SSB transmissions within a preconfigured time window. In some examples, the preconfigured time window for the CD-SSB may be 5 milliseconds (ms).

The 3GPP standard specification for 5G NR may also provide support for a non-cell-defining SSB (NCD-SSB). An NCD-SSB may include four consecutive symbols and may include the PSS, the SSS, and the PBCH. The PBCH in the NCD-SSB may not include scheduling information for SIB 1. Therefore, in some examples, SIB1 may not be transmitted together with the NCD-SSB. One or more NCD-SSBs may be transmitted in a preconfigured time window. In some examples, the preconfigured time window for the NCD-SSB may be 5 ms. In some examples, the preconfigured time window for the NCD-SSB may be in a first or second half of a 10 ms radio frame.

Some types of UEs in a network may have reduced capabilities (also referred to as low-tier UEs as introduced in Release 17 of the 3GPP standard specification or reduced capability (RedCap) UEs). Low-tier UEs (including RedCap UEs) may include, for example, wearables (e.g., smart wearables, such as smartwatches), industrial wireless sensor networks (IWSN), surveillance cameras, low-end smartphones, and/or relaxed IoT devices. For example, low-tier UEs will typically have more capability (e.g., processing capacity, features, battery performance, etc.) than an IoT device (e.g., a Narrowband Internet of Things (NB-IoT) device) but less capability than regular UEs (e.g., regular UEs as defined in Release 17 of the 3GPP standard specification). For example, a regular UE may be an Enhanced Mobile Broadband (eMBB) smartphone. Moreover, low-tier UEs may typically be more sensitive to power consumption than regular UEs. For example, a low-tier UE operating in a connected mode may have capability to receive an NCD-SSB transmitted from a network access node (e.g., a base station, TRP, etc.).

A network access node may explicitly indicate to the UE (e.g., a low-tier UE, regular UE) the frequency of the NCD-SSB in a serving cell and the periodicity of the NCD-SSB in the serving cell. For example, the network access node may transmit a first parameter (also referred to as absoluteFrequencySSB) that includes a frequency value for the NCD-SSB (e.g., the frequency value to which the NCD-SSB will be mapped) and a second parameter (also referred to as ssb-PeriodicityServingCell) that includes a periodicity value for the NCD-SSB. The periodicity value for the NCD-SSB may indicate how often the NCD-SSB will be transmitted.

In some examples, other parameters of an NCD-SSB in a serving cell may be configured with the same values as the CD-SSB of the serving cell. For example, a Physical layer Cell Identifier (PCI), a parameter indicating a transmit power of the NCD-SSB (also referred to as an ss-PBCH-BlockPower parameter), and a parameter indicating a transmission pattern of the NCD-SSB (also referred to as an ssb-PositionsInBurst parameter) may be configured with the same values as the CD-SSB of the serving cell. For example, the ssb-PositionsInBurst parameter may be an index associated with one SSB in a burst of multiple consecutive SSB transmissions.

A network access node may transmit both the NCD-SSB and the CD-SSB in the serving cell of a low-tier UE. In some examples, the CD-SSB is transmitted periodically and may be used by any type of UE (e.g., a regular UE, low-tier UE). In some examples, the NCD-SSB is transmitted at least in the RRC-configured DL bandwidth part of a low-tier UE.

In some examples, a low-tier UE and a regular UE may use both the NCD-SSB and the CD-SSB for layer 1 (also referred to as L1) and/or layer 3 (also referred to as L3) measurements. For example, a regular UE may support the use of the NCD-SSB for layer 1 and/or layer 3 measurements as an optional capability. If a regular UE is not able to support NCD-SSB measurements on the serving cell, additional rate matching pattern(s) may be indicated to the regular UE to enable NCD-SSB reception and measurements on the serving cell.

If the NCD-SSB is transmitted in the RRC-configured DL bandwidth part of a low-tier UE, configuration information of the NCD-SSB may be included in system information (SI) and/or a radio resource control (RRC) message. An availability indication of the NCD-SSB may be provided in DCI, a medium access control (MAC) control element (CE) (also abbreviated as MAC-CE), and/or an RRC message. In some examples, the NCD-SSB may be activated by DCI, a MAC-CE, or dedicated RRC signaling.

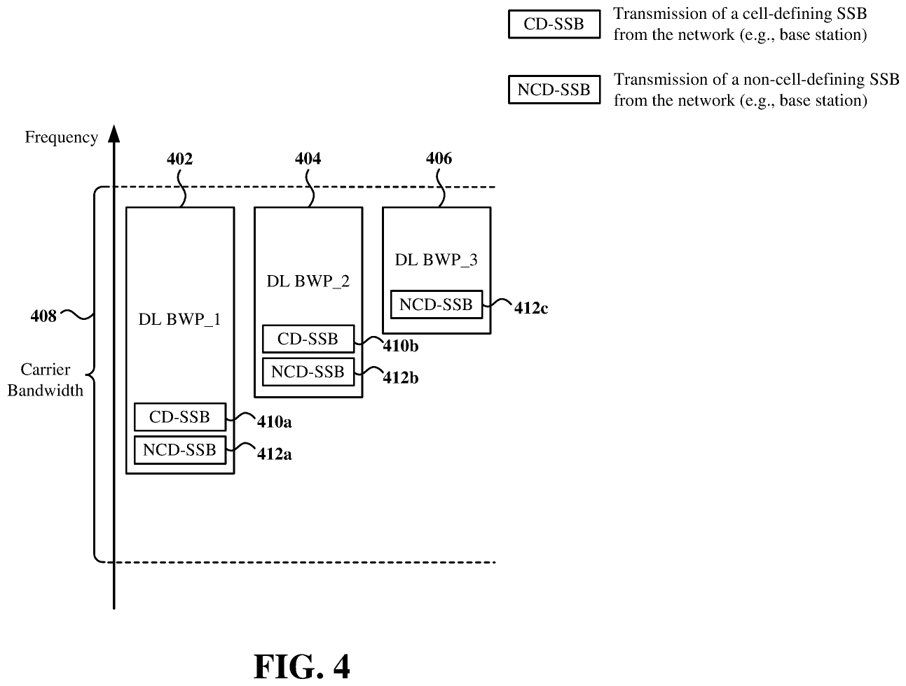

FIG. 4 illustrates example bandwidth parts of a carrier bandwidth in accordance with various aspects of the disclosure. FIG. 4 includes a first DL bandwidth part 402 (abbreviated as DL BWP_1 in FIG. 4), a second DL bandwidth part 404 (abbreviated as DL BWP_2 in FIG. 4), and a third DL bandwidth part 406 (abbreviated as DL BWP_3 in FIG. 4). Each of the first, second, and third DL bandwidth parts 402, 404, 406 may include a portion of a carrier bandwidth 408.

In one example, the first DL bandwidth part 402 may be allocated to a regular UE, the second DL bandwidth part 404 may be allocated to a first low-tier UE, and the third DL bandwidth part 406 may be allocated to a second low-tier UE. In some examples, a CD-SSB 410a and an NCD-SSB 412a may be transmitted from the network (e.g., a base station) in the first DL bandwidth part 402, a CD-SSB 410b and an NCD-SSB 412b may be transmitted from the network (e.g., a base station) in the second DL bandwidth part 404, and an NCD-SSB 412c may be transmitted from the network (e.g., a base station) in the third DL bandwidth part 406.

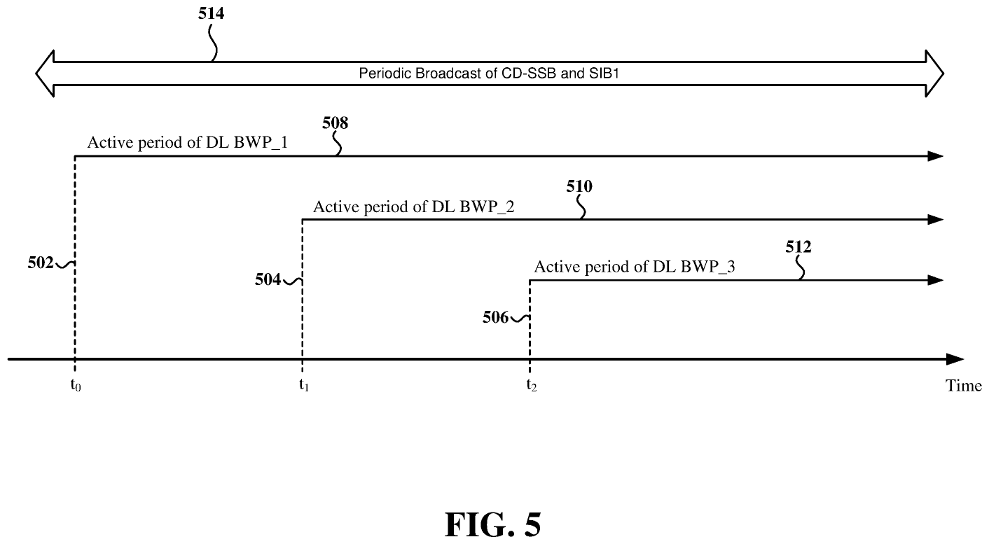

FIG. 5 illustrates a bandwidth part activation timing diagram for the first, second, and third DL bandwidth parts 402, 404, 406 described with reference to FIG. 4. The first DL bandwidth part 402 may be activated at time to 502, the second DL bandwidth part 404 may be activated at time t₁ 504, and the third DL bandwidth part 406 may be activated at time t₂ 506. Therefore, in the example of FIG. 5, the active period 508 of the first DL bandwidth part 402 exceeds the active period 510 of the second DL bandwidth part 404, and the active period 510 of the second DL bandwidth part 404 exceeds the active period 512 of the third DL bandwidth part 406.

As indicated with the CD-SSB and SIB1 transmission timing 514 in FIG. 5, a CD-SSB and SIM may be broadcast periodically and may be “always on.” For example, the CD-SSBs 410a, 410b in FIG. 4 may be periodically broadcast in the first and second DL bandwidth parts 402, 404.

With respect to the NCD-SSB, the resource mapping, availability and activation timer of the NCD-SSB may be separately configured and indicated to a UE. In some examples, the resource mapping, availability and activation timer of the NCD-SSB may be indicated to a UE when the UE is in an idle mode, an inactive mode, or a connected mode. In some examples, the resource mapping, availability and activation timer for an NCD-SSB may be indicated to a UE via system information (SI), an RRC message, a MAC CE, or DCI. In some examples, the DCI also includes paging DCI and paging early indication DCI.

The transmit power of the CD-SSB can be different from the transmit power of the NCD-SSB. In some examples, the energy per resource element (EPRE) boosting level for the PSS, the SSS, and the DMRS of PBCH can be separately configured for CD-SSB and NCD-SSB. For example, a first EPRE boosting level may be configured for the CD-SSB and a second EPRE boosting level may be configured for the NCD-SSB in a system information (SI) message or an RRC message.

A power control offset parameter (also referred to as powerControlOffsetSS) in RRC may indicate an offset for a DL reference signal transmission power (e.g., a CSI-RS transmission power) relative to the CD-SSB transmission power or the NCD-SSB transmission power. The DL reference signal may be quasi-colocated (QCLed) with the CD-SSB and the NCD-SSB. In some examples, separate power control offset parameters may be configured for the CD-SSB and the NCD-SSB. For example, a first power control offset parameter may be configured for the CD-SSB and a second power control offset parameter may be configured for the NCD-SSB.

In some examples, a repetition pattern for the PSS symbols, the SSS symbols, and PBCH symbols within an SSB block can be separately configured for the CD-SSB and the NCD-SSB. In some examples, an SSB to RACH occasion (SSB-to-RO) association pattern and association periodicity can be different for the CD-SSB and the NCD-SSB. For example, the repetition pattern and SSB-to-RO may be configured separately for the CD-SSB and the NCD-SSB using RRC parameters in system information (SI).

Measurements and reporting operations for the CD-SSB and the NCD-SSB can have different configurations. For example, when both the CD-SSB and the NCD-SSB are transmitted in a DL bandwidth part of a UE, the network (e.g., a base station, TRP, etc.) can explicitly indicate whether the CD-SSB, the NCD-SSB, or a combination of the CD-SSB and the NCD-SSB should be used for a procedure or operation of the UE. In some examples, a measurement of the CD-SSB and/or the NCD-SSB may be used for an operation associated with a RACH procedure (including a contention-based RACH procedure and a contention free RACH procedure), an operation for determining a transmission configuration indicator (TCI) state for different DL channels, a determination of an uplink spatial relation for an uplink channel, a layer 1 reference signal received power (L1-RSRP) reporting operation, a radio link monitoring operation, a beam failure detection, a candidate beam detection, and/or a beam failure recovery operation.

In some examples, if a reference signal (e.g., the CD-SSB and/or the NCD-SSB) to be used for a measurement is not explicitly indicated to the UE by the network (e.g., a base station, TRP, etc.), the UE can follow a priority rule to determine the reference signal (e.g., the CD-SSB and/or the NCD-SSB) to be used. In some examples, the priority rule may be based on a duplex mode of the UE, a paging search space configuration associated with a discontinuous reception configuration, a capability of the UE, and/or one or more conditions for relaxing a layer 1 measurement or a layer 3 measurement.

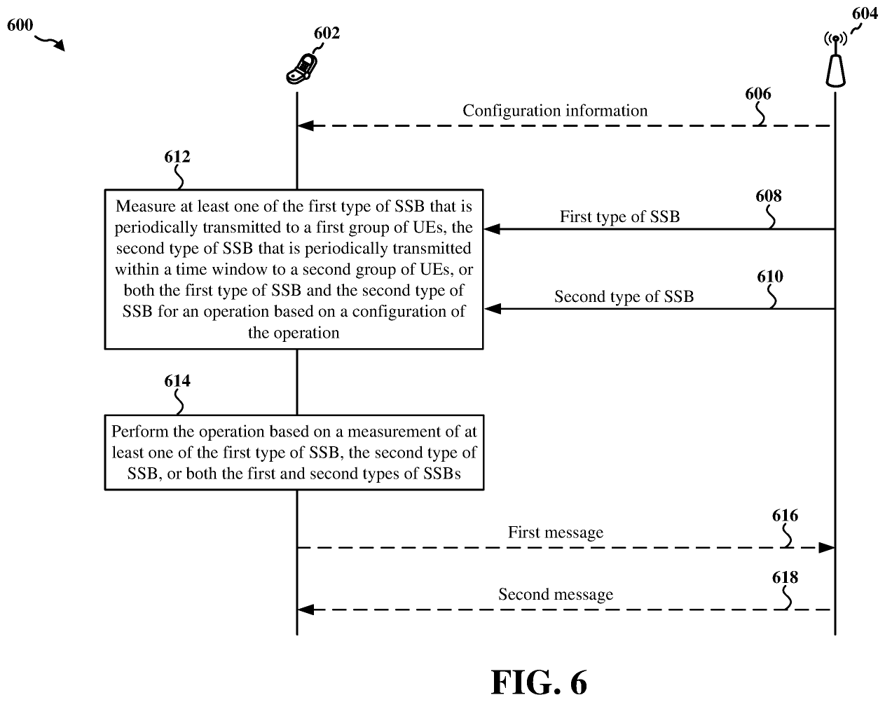

FIG. 6 is a signal flow diagram 600 in accordance with various aspects of the disclosure. FIG. 6 includes a UE 602 and a base station 604. The UE 602 may be a regular UE or a low-tier UE as described herein.

In some aspects, the base station 604 may optionally transmit configuration information 606 to the UE 602. In some examples, the configuration information 606 may be included in an RRC message. The configuration information 606 may include a configuration for an operation to be performed at the UE 602.

The base station 604 may transmit a first type of SSB 608. In some examples, the first type of SSB may be a CD-SSB. The first type of SSB 608 may be periodically transmitted to a first group of UEs. For example, the first group of UEs may include one or more UEs of a first type, such as regular UEs. In some examples, the first group of UEs may not include any low-tier UEs. In some examples, the first type of SSB 608 is constantly on and is broadcast to all UEs (e.g., all types of UEs including regular UEs and low-tier UEs).

The base station 604 may transmit a second type of SSB 610. In some examples, the second type of SSB 610 may be an NCD-SSB. The second type of SSB 610 may be periodically transmitted within a time window to a second group of UEs. For example, the second group of UEs may include one or more UEs of a second type, such as low-tier UEs. In some examples, the second group of UEs may not include regular UEs. In some examples, the UEs of the second type may have reduced capabilities relative to the UEs of the first type.

In some examples, the first type of SSB 608 and the second type of SSB 610 are transmitted in a same bandwidth part of the UE 602. For example, the first type of SSB 608 and the second type of SSB 610 may be transmitted in the first DL bandwidth part 402 or in the second DL bandwidth part 404 as previously described with reference to FIG. 4.

At 612, the UE 602 may measure at least one of the first type of SSB 608 that is periodically transmitted to the first group of UEs, the second type of SSB 610 that is periodically transmitted within a time window to a second group of UEs, or both the first type of SSB 608 and the second type of SSB 610 for an operation based on a configuration of the operation.

In some aspects of the disclosure, the configuration of the operation in the configuration information 606 may explicitly indicate to use the first type of SSB 608, the second type of SSB 610, or both the first type of SSB 608 and the second type of SSB 610 for the operation. In some aspects of the disclosure, the configuration of the operation may be based on one or more priority rules applied at the UE 602.

In some examples, the one or more priority rules may indicate to measure at least one of the first type of SSB 608, the second type of SSB 610, or both the first type of SSB 608 and the second type of SSB 610 for the operation based on at least one of a duplex mode of the UE 602, a radio resource control (RRC) state, a timer configuration, a type of mobility procedure, a status of multi-connectivity with one or multiple network entities, execution criteria used for conditional reconfiguration of the measurement, execution criteria used for measurement reporting, a measurement gap configuration, a location measurement configuration, a paging search space configuration, a capability of the apparatus, or one or more conditions for relaxing a layer 1 measurement or a layer 3 measurement. In some aspects of the disclosure, the one or more priority rules may be included in the configuration information 606 in scenarios where the configuration information 606 does not explicitly indicate to use the first type of SSB 608, the second type of SSB 610, or both the first type of SSB 608 and the second type of SSB 610 for the operation.

For example, a type of mobility procedure may include a handover, a conditional handover, a dual active protocol stack handover, and/or a cell selection/re-selection. For example, a status of multi-connectivity with one or multiple network entities may include carrier aggregation, NR dual connectivity (DC), multi-TRP, and/or sidelink connectivity.

In some examples, a first transmit power of the first type of SSB 608 is different from a second transmit power of the second type of SSB 610. In some examples, a first SSB symbol repetition pattern of the first type of SSB 608 is different from a second SSB symbol repetition pattern of the second type of SSB 610. In some examples, a first SSB to network access occasion association pattern of the first type of SSB 608 is different from a second SSB to network access occasion association pattern of the second type of SSB 610. In some examples, a first SSB to network access occasion association periodicity of the first type of SSB 608 is different from a second SSB to network access occasion association periodicity of the second type of SSB 610. For example, an SSB to network access occasion association pattern may be an SSB to RACH occasion (SSB-to-RO) association pattern, and an SSB to network access occasion association periodicity may be an SSB to RACH occasion (SSB-to-RO) association periodicity.

At 614, the UE 602 may perform the operation based on a measurement of at least one of the first type of SSB 608, the second type of SSB 610, or both the first and second types of SSBs 608, 610.

In some examples, the operation to be performed at the UE 602 may be an operation associated with a RACH procedure (including a contention-based RACH procedure and a contention free RACH procedure), an operation for determining a transmission configuration indicator (TCI) state for different DL channels, a determination of an uplink spatial relation for an uplink channel, a layer 1 reference signal received power (L1-RSRP) reporting operation, a radio link monitoring operation, a beam failure detection, a candidate beam detection, a beam failure recovery operation, or other type of operation based on a measurement of at least the first type of SSB 608, the second type of SSB 610, or both the first and second types of SSBs 608, 610.

In some examples, the operation associated with a RACH procedure may include a determination of a random access channel occasion (also referred to as a RACH occasion). For example, the UE 602 may determine a RACH occasion based on one or more types of SSBs (e.g. CD-SSB, NCD-SSB) supported by the capability of the UE 602, the bandwidth part configuration of the UE 602, the time window configured for the RACH procedure, a trigger event of a RACH procedure, and/or a RACH occasion associated with one or more types of SSBs available to the UE 602 and which has the highest or threshold measured signal strength.

In some examples, the UE 602 may perform the operation for determining a TCI state for a downlink channel by reporting measurements for the first type of SSB 608 and the second type of SSB 610. For example, the UE 602 may transmit measurements for the first type of SSB 608 and the second type of SSB 610 obtained at 612 in the first message 616. Based on the measurements in the first message 616, the base station 604 may configure one or more TCI states (e.g., via RRC information included in the second message 618) for a DL control channel and/or a DL data channel of the UE 602.

In some examples, the UE 602 may perform the operation associated with a determination of an uplink spatial relation for an uplink channel. In some examples, the UE 602 may perform an L1-RSRP reporting operation by transmitting the first message 616 including measurements (e.g., RSRP values) of at least one of the first type of SSB 608, the second type of SSB 608, or both the first and second types of SSBs 608, 610.

In some examples, the UE 602 may perform a radio link monitoring operation by comparing the measurements of at least one of the first type of SSB 608, the second type of SSB 610, or both the first and second types of SSBs 608, 610 to a threshold radio link quality value (e.g., a threshold RSRP value) and providing in-sync (IS) and out-of-sync (00S) indications to higher layers of the UE 602 based on the comparisons. Therefore, in some examples, the UE 602 may use the first type of SSB 608, the second type of SSB 610, or both the first and second types of SSBs 608, 610 as radio link monitoring reference signals (RLM-RSs).

In some examples, the UE 602 may perform a beam failure detection by comparing the measurements (e.g., measured Signal-to-Interference-and-Noise Ratio (SINR) values) of at least one of the first type of SSB 608, the second type of SSB 610, or both the first and second types of SSBs 608, 610 to a threshold value Q_{out_LR}. For example, the threshold value Q_{out_LR} may be a threshold SINR value that maps to a block error rate (BLER) of 10%. The UE 602 may provide beam failure instance indications (BFIs) to higher layers of the UE 602 based on the comparisons and a beam failure detection may be declared at the UE 602 if a maximum number of beam failure instance indications is reached. Therefore, in some examples, the UE 602 may use the first type of SSB 608, the second type of SSB 610, or both the first and second types of SSBs 608, 610 as beam failure detection reference signals (BFD-RSs).

In some examples, the UE 602 may detect a candidate beam by determining whether the first type of SSB 608 or the second type of SSB 610 has a measured signal strength (e.g., an RSRP value) that exceeds a threshold value. The UE 602 may select the beam corresponding to the first type of SSB 608 or the second type of SSB 610 having the measured signal strength that exceeds the threshold value as the candidate beam.

In some examples, the operation to be performed at the UE 602 is a differential reference signal received power reporting operation which enables the UE 602 to report a difference between the signal strengths (e.g., L1-RSRP measurements) of the first type of SSB 608 and the second type of SSB 610. In some implementations, the difference between the signal strengths of the first type of SSB 608 and the second type of SSB 610 may allow the base station 604 to understand the properties of the total carrier.

For example, the UE 602 may perform the differential reference signal received power reporting operation by determining a difference between a first signal strength of the first type of SSB 608 and a second signal strength of the second type of SSB 610. The UE 602 may transmit the first message 616 including a measurement report containing the difference between the first signal strength of the first type of SSB 608 and the second signal strength of the second type of SSB 610.

In some examples, reporting of the differential reference signal received power may reduce the reporting overhead of a UE. For example, if the UE is allowed to report measurements for the same SSB index, the UE may include the first signal strength of the first type of SSB 608 and the differential reference signal received power. Since the second signal strength of the second type of SSB 610 may be determined from the first signal strength of the first type of SSB 608 and the differential reference signal received power, the UE may effectively indicate the second signal strength of the second type of SSB 610 without including the second signal strength of the second type of SSB 610 (e.g., which may involve a larger amount of information relative to the differential reference signal received power) in a measurement report. As a result, the reporting overhead of the UE may be reduced.

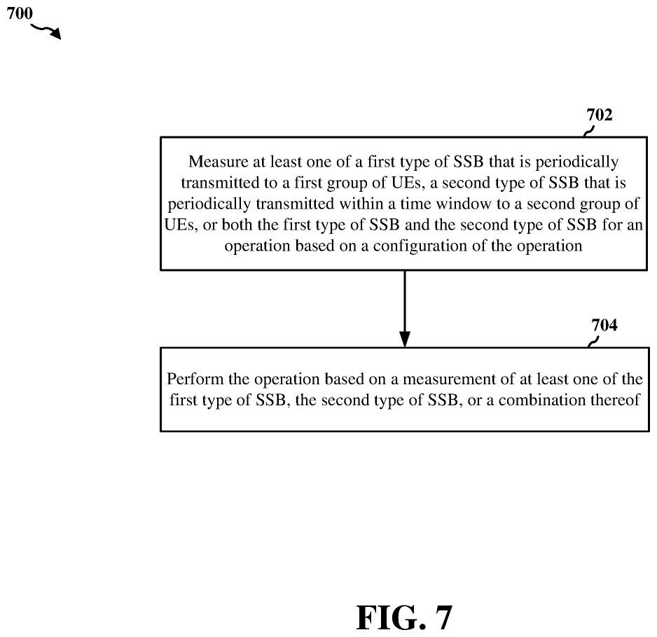

FIG. 7 is a flowchart 700 of a method of wireless communication. The method may be performed by a UE (e.g., the UE 104, 602; the apparatus 902/902′; the processing system 1014, which may include the memory 360 and which may be the entire UE 104, 602 or a component of the UE 104, 602, such as the TX processor 368, the RX processor 356, and/or the controller/processor 359).

At 702, the UE measures at least one of a first type of SSB that is periodically transmitted to a first group of UEs, a second type of SSB that is periodically transmitted within a time window to a second group of UEs, or both the first type of SSB and the second type of SSB for an operation based on a configuration of the operation. For example, with reference to FIG. 6, the UE 602 may measure at least one of the first type of SSB 608 that is periodically transmitted to a first group of UEs, the second type of SSB 610 that is periodically transmitted within a time window to a second group of UEs, or both the first type of SSB 608 and the second type of SSB 610 for an operation based on a configuration of the operation.

For example, the first type of SSB 608 may be a CD-SSB and the second type of SSB 610 may be an NCD-SSB. In some aspects, the CD-SSB is constantly on and is broadcast to all UEs. In some aspects, the NCD-SSB is activated by DCI, a MAC-CE, or dedicated RRC signaling.

Finally, at 704, the UE performs the operation based on a measurement of at least one of the first type of SSB, the second type of SSB, or a combination thereof. In some aspects, the operation includes a determination of a random access channel occasion, a determination of a TCI state for a downlink channel, a determination of an uplink spatial relation for an uplink channel, an L1-RSRP reporting operation, a radio link monitoring operation, a beam failure detection, a candidate beam detection, or a beam failure recovery operation. In some aspects, the operation is a differential reference signal received power reporting operation, where the UE transmits a message including a measurement report containing a difference between a first signal strength of the first type of SSB and a second signal strength of the second type of SSB.

In some aspects, the UE receives the configuration of the operation, wherein the configuration of the operation indicates to use the first type of SSB, the second type of SSB, or both the first type of SSB and the second type of SSB for the operation. In some aspects, the configuration of the operation is based on one or more priority rules, wherein the one or more priority rules indicates to measure at least one of the first type of SSB, the second type of SSB, or both the first type of SSB and the second type of SSB for the operation based on at least one of a duplex mode of the UE, a radio resource control (RRC) state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the UE, or one or more conditions for relaxing a layer 1 measurement or a layer 3 measurement.

In some aspects, the first type of SSB and the second type of SSB are transmitted in a same bandwidth part of the UE. In one example, with reference to FIG. 4, the CD-SSB 410a and the NCD-SSB 412a may be transmitted in the first DL bandwidth part 402.

In some aspects, the first group of UEs includes one or more UEs of a first type (e.g., one or more regular UEs), and the second group of UEs includes one or more UEs of a second type (one or more low-tier UEs). The one or more UEs of the second type may have reduced capabilities relative to the one or more UEs of the first type.

In some aspects, a first transmit power of the first type of SSB is different from a second transmit power of the second type of SSB. In some aspects, a first SSB symbol repetition pattern of the first type of SSB is different from a second SSB symbol repetition pattern of the second type of SSB. In some aspects, a first SSB to network access occasion association pattern (e.g., a first SSB-to-RO association pattern) of the first type of SSB is different from a second SSB to network access occasion association pattern (e.g., a second SSB-to-RO association pattern) of the second type of SSB, and wherein a first SSB to network access occasion association periodicity of the first type of SSB is different from a second SSB to network access occasion association periodicity of the second type of SSB.

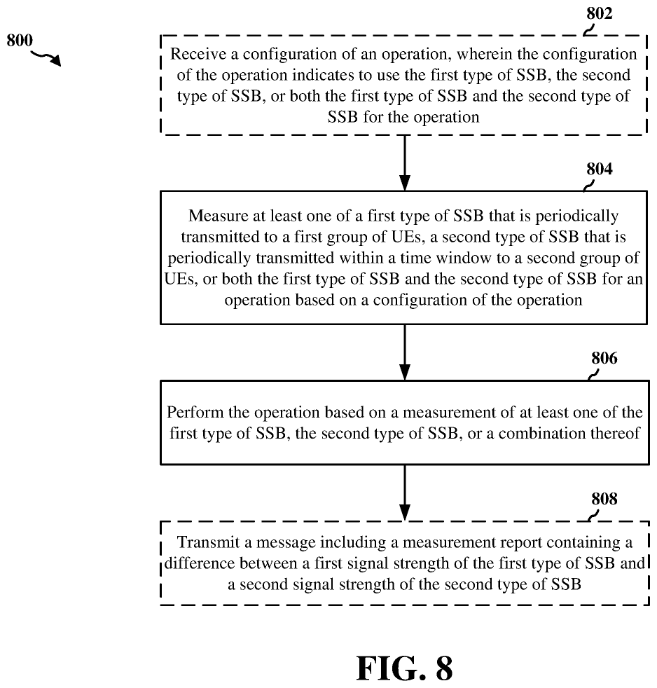

FIG. 8 is a flowchart 800 of a method of wireless communication. The method may be performed by a UE (e.g., the UE 104, 602; the apparatus 902/902′; the processing system 1014, which may include the memory 360 and which may be the entire UE 104, 602 or a component of the UE 104, 602, such as the TX processor 368, the RX processor 356, and/or the controller/processor 359). It should be understood that blocks indicated with dashed lines in FIG. 8 represent optional blocks.

At 802, the UE optionally receives a configuration of an operation, wherein the configuration of the operation indicates to use the first type of SSB, the second type of SSB, or both the first type of SSB and the second type of SSB for the operation.

In one example, with reference to FIG. 6, the UE 602 may receive the configuration information 606 from the base station 604. The configuration of the operation in the configuration information 606 may explicitly indicate to use the first type of SSB 608, the second type of SSB 610, or both the first type of SSB 608 and the second type of SSB 610 for the operation.

In some aspects of the disclosure, the configuration of the operation may be based on one or more priority rules. For example, in scenarios where the configuration information 606 does not explicitly indicate to use the first type of SSB 608, the second type of SSB 610, or both the first type of SSB 608 and the second type of SSB 610 for the operation, the UE may apply one or more priority rules to determine the configuration of the operation. In some examples, the one or more priority rules may indicate to measure at least one of the first type of SSB, the second type of SSB, or both the first type of SSB and the second type of SSB for the operation based on at least one of a duplex mode of the UE, a radio resource control (RRC) state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the UE, or one or more conditions for relaxing a layer 1 measurement or a layer 3 measurement. In some aspects, the one or more priority rules may be included in the configuration information 606.

At 804, the UE measures at least one of a first type of SSB that is periodically transmitted to a first group of UEs, a second type of SSB that is periodically transmitted within a time window to a second group of UEs, or both the first type of SSB and the second type of SSB for an operation based on a configuration of the operation.

For example, with reference to FIG. 6, the UE 602 may measure at least one of the first type of SSB 608 that is periodically transmitted to a first group of UEs, the second type of SSB 610 that is periodically transmitted within a time window to a second group of UEs, or both the first type of SSB 608 and the second type of SSB 610 for an operation based on a configuration of the operation.

For example, the first type of SSB 608 may be a CD-SSB and the second type of SSB 610 may be an NCD-SSB. In some aspects, the CD-SSB is constantly on and is broadcast to all UEs. In some aspects, the NCD-SSB is activated by DCI, a MAC-CE, or dedicated RRC signaling.

In some aspects, the first type of SSB and the second type of SSB are transmitted in a same bandwidth part of the UE. In one example, with reference to FIG. 4, the CD-SSB 410a and the NCD-SSB 412a may be transmitted in the first DL bandwidth part 402.

In some aspects, the first group of UEs includes one or more UEs of a first type (e.g., one or more regular UEs), and wherein the second group of UEs includes one or more UEs of a second type (one or more low-tier UEs), wherein the one or more UEs of the second type have reduced capabilities relative to the one or more UEs of the first type.

In some aspects, a first transmit power of the first type of SSB is different from a second transmit power of the second type of SSB. In some aspects, a first SSB symbol repetition pattern of the first type of SSB is different from a second SSB symbol repetition pattern of the second type of SSB. In some aspects, a first SSB to network access occasion association pattern (e.g., a first SSB-to-RO association pattern) of the first type of SSB is different from a second SSB to network access occasion association pattern (e.g., a second SSB-to-RO association pattern) of the second type of SSB, and wherein a first SSB to network access occasion association periodicity of the first type of SSB is different from a second SSB to network access occasion association periodicity of the second type of SSB.

At 806, the UE performs the operation based on a measurement of at least one of the first type of SSB, the second type of SSB, or a combination thereof.

In some aspects, the operation includes a determination of a random access channel occasion, a determination of a TCI state for a downlink channel, a determination of an uplink spatial relation for an uplink channel, an L1-RSRP reporting operation, a radio link monitoring operation, a beam failure detection, a candidate beam detection, or a beam failure recovery operation. In some aspects, the operation is a differential reference signal received power reporting operation

Finally, at 808, the UE optionally transmits a message including a measurement report containing a difference between a first signal strength of the first type of SSB and a second signal strength of the second type of SSB.

For example, if the operation is a differential reference signal received power reporting operation, the UE 602 may perform the differential reference signal received power reporting operation by determining a difference between a first signal strength of the first type of SSB 608 and a second signal strength of the second type of SSB 610. The UE 602 may transmit the first message 616 including a measurement report containing the difference between the first signal strength of the first type of SSB 608 and the second signal strength of the second type of SSB 610.

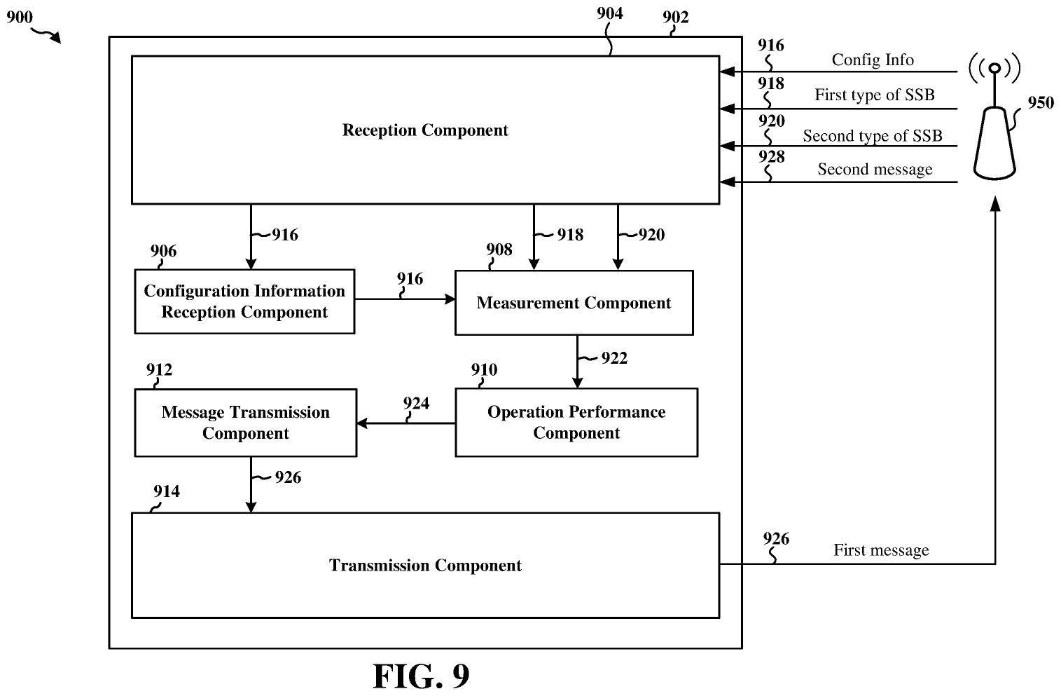

FIG. 9 is a conceptual data flow diagram 900 illustrating the data flow between different means/components in an example apparatus 902. The apparatus may be a UE. The apparatus includes a reception component 904 that receives downlink (DL) transmissions from the base station 950. The apparatus further includes a configuration information reception component 906 that receives (e.g., via the reception component 904) configuration information 916 including a configuration of an operation, wherein the configuration of the operation indicates to use a first type of SSB 918, a second type of SSB 920, or both the first type of SSB 918 and the second type of SSB 920 for the operation.

The apparatus further includes a measurement component 908 that measures at least one of the first type of SSB 918 that is periodically transmitted to a first group of UEs, the second type of SSB 920 that is periodically transmitted within a time window to a second group of UEs, or both the first type of SSB 918 and the second type of SSB 920 for an operation based on a configuration of the operation. The measurement component 908 may receive the configuration information 916 from the configuration information reception component 906. The measurement component 908 may provide measurement information 922 that includes one or more measurements of the first type of SSB 918, the second type of SSB 920, or both the first type of SSB 918 and the second type of SSB 920.

The apparatus further includes an operation performance component 910 that receives the measurement information 922 and performs the operation based on a measurement of at least one of the first type of SSB 918, the second type of SSB 920, or a combination thereof. The operation performance component 910 may provide information 924 associated with the operation (e.g., a measurement report).

The apparatus further includes a message transmission component 912 that transmits a message (e.g., via the transmission component 914), such as the first message 926, to the base station 950. The message transmission component 912 may receive the information 924 associated with the operation and may include the information 924 associated with the operation in the first message 926. For example, the first message 926 may include a measurement report containing a difference between a first signal strength of the first type of SSB and a second signal strength of the second type of SSB.

In some examples, the reception component 904 receives a second message 928. The second message 928 may include RRC information based on the first message 926 (e.g., RRC information containing one or more TCI states). The apparatus further includes a transmission component 914 that transmits uplink (UL) transmissions to the base station 950.

The apparatus may include additional components that perform each of the blocks of the algorithm in the aforementioned flowcharts of FIGS. 7 and 8. As such, each block in the aforementioned flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

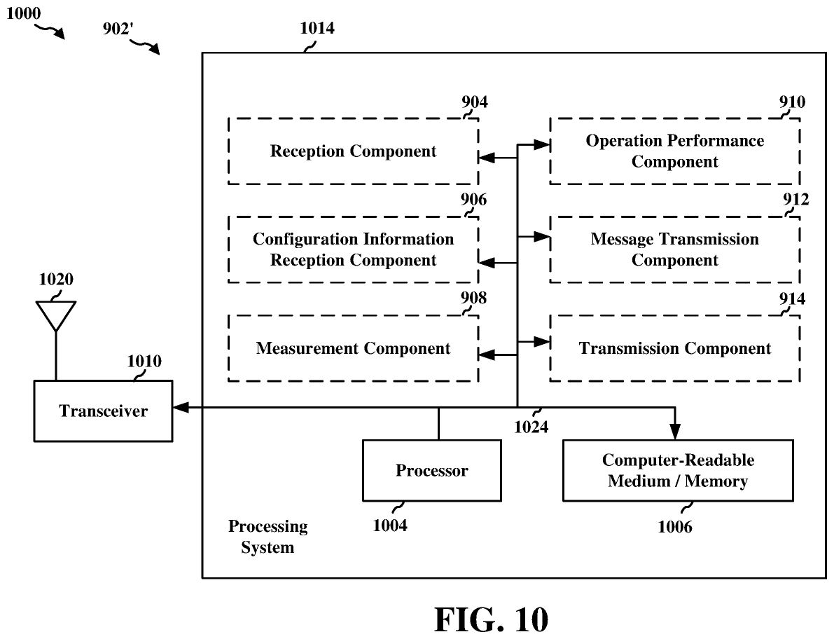

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, 910, 912, 914 and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 914, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908, 910, 912, 914. The components may be software components running in the processor 1004, resident/stored in the computer readable medium/memory 1006, one or more hardware components coupled to the processor 1004, or some combination thereof. The processing system 1014 may be a component of the UE 350 and may include the memory 360 and/or at least one of the TX processor 368, the RX processor 356, and the controller/processor 359. Alternatively, the processing system 1014 may be the entire UE (e.g., see 350 of FIG. 3).

In one configuration, the apparatus 902/902′ for wireless communication includes means for receiving the configuration of the operation, wherein the configuration of the operation indicates to use the first type of SSB, the second type of SSB, or both the first type of SSB and the second type of SSB for the operation, means for measuring at least one of a first type of SSB that is periodically transmitted to a first group of UEs, a second type of SSB that is periodically transmitted within a time window to a second group of UEs, or both the first type of SSB and the second type of SSB for an operation based on a configuration of the operation, means for performing the operation based on a measurement of at least one of the first type of SSB, the second type of SSB, or a combination thereof, and means for transmitting a message including a measurement report containing a difference between a first signal strength of the first type of SSB and a second signal strength of the second type of SSB. The aforementioned means may be one or more of the aforementioned components of the apparatus 902 and/or the processing system 1014 of the apparatus 902′ configured to perform the functions recited by the aforementioned means. As described supra, the processing system 1014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

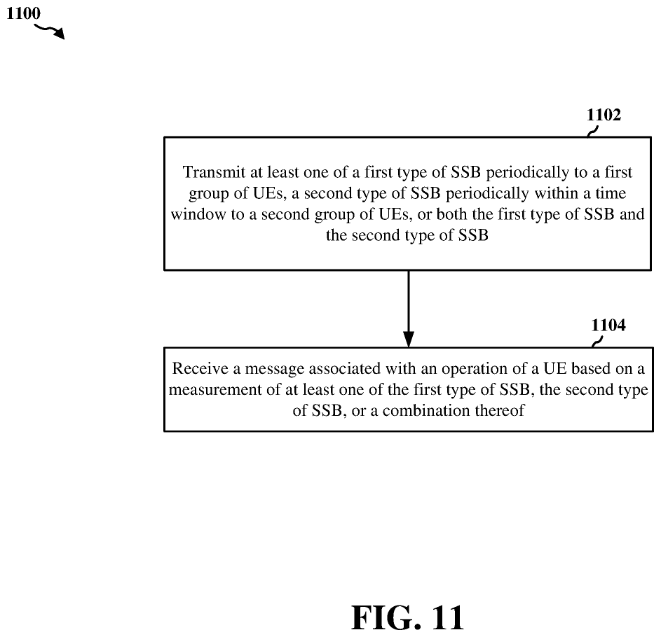

FIG. 11 is a flowchart 1100 of a method of wireless communication. The method may be performed by a base station (e.g., the base station 604; the apparatus 1304/1304′; the processing system 1414, which may include the memory 376 and which may be the entire base station 604 or a component of the base station 604, such as the TX processor 316, the RX processor 370, and/or the controller/processor 375).

At 1102, the base station transmits at least one of a first type of SSB periodically to a first group of UEs, a second type of SSB periodically within a time window to a second group of UEs, or both the first type of SSB and the second type of SSB.

For example, with reference to FIG. 6, the base station 604 may transmit at least one of the first type of SSB 608 periodically to a first group of UEs, the second type of SSB 610 periodically within a time window to a second group of UEs, or both the first type of SSB 608 and the second type of SSB 610. For example, the first type of SSB 608 may be a CD-SSB and the second type of SSB 610 may be an NCD-SSB. In some aspects, the CD-SSB is constantly on and is broadcast to all UEs. In some aspects, the base station activates the NCD-SSB by DCI, a MAC-CE, or dedicated RRC signaling.

In some aspects, the first type of SSB and the second type of SSB are transmitted in a same bandwidth part of the UE. In one example, with reference to FIG. 4, the CD-SSB 410a and the NCD-SSB 412a may be transmitted in the first DL bandwidth part 402.

In some aspects, the first group of UEs includes one or more UEs of a first type (e.g., one or more regular UEs), and wherein the second group of UEs includes one or more UEs of a second type (one or more low-tier UEs), wherein the one or more UEs of the second type have reduced capabilities relative to the one or more UEs of the first type.

In some aspects, a first transmit power of the first type of SSB is different from a second transmit power of the second type of SSB. In some aspects, a first SSB symbol repetition pattern of the first type of SSB is different from a second SSB symbol repetition pattern of the second type of SSB. In some aspects, a first SSB to network access occasion association pattern (e.g., a first SSB-to-RO association pattern) of the first type of SSB is different from a second SSB to network access occasion association pattern (e.g., a second SSB-to-RO association pattern) of the second type of SSB, and wherein a first SSB to network access occasion association periodicity of the first type of SSB is different from a second SSB to network access occasion association periodicity of the second type of SSB.

Finally, at 1104, the base station receives a message associated with an operation of a UE based on a measurement of at least one of the first type of SSB, the second type of SSB, or a combination thereof.

In some aspects, the message includes a measurement report containing a difference between a first signal strength of the first type of SSB and a second signal strength of the second type of SSB. For example, the operation of the UE may a differential reference signal received power reporting operation. The UE 602 may perform the differential reference signal received power reporting operation by determining a difference between a first signal strength of the first type of SSB 608 and a second signal strength of the second type of SSB 610. The UE 602 may transmit the first message 616 including a measurement report containing the difference between the first signal strength of the first type of SSB 608 and the second signal strength of the second type of SSB 610.

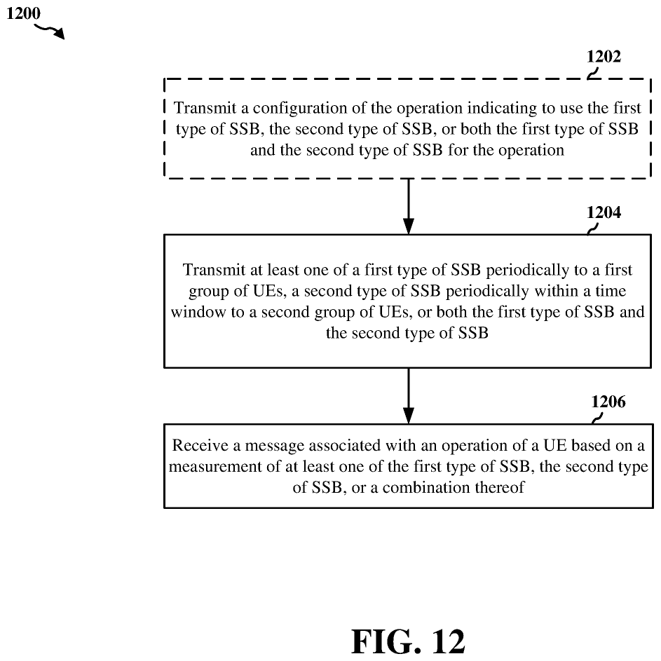

FIG. 12 is a flowchart 1200 of a method of wireless communication. The method may be performed by a base station (e.g., the base station 604; the apparatus 1304/1304′; the processing system 1414, which may include the memory 376 and which may be the entire base station 604 or a component of the base station 604, such as the TX processor 316, the RX processor 370, and/or the controller/processor 375). It should be understood that blocks indicated with dashed lines in FIG. 12 represent optional blocks.

At 1202, the base station transmits a configuration of the operation indicating to use the first type of SSB, the second type of SSB, or both the first type of SSB and the second type of SSB for the operation.

In one example, with reference to FIG. 6, the base station 604 may transmit the configuration information 606. The configuration of the operation in the configuration information 606 may explicitly indicate to use the first type of SSB 608, the second type of SSB 610, or both the first type of SSB 608 and the second type of SSB 610 for the operation.

In some aspects of the disclosure, the configuration of the operation may be based on one or more priority rules to be applied at a UE (e.g., the UE 602 in FIG. 6). For example, in scenarios where the configuration information 606 does not explicitly indicate to use the first type of SSB 608, the second type of SSB 610, or both the first type of SSB 608 and the second type of SSB 610 for the operation, the UE may apply one or more priority rules to determine the configuration of the operation. In some examples, the one or more priority rules may indicate to measure at least one of the first type of SSB, the second type of SSB, or both the first type of SSB and the second type of SSB for the operation based on at least one of a duplex mode of the UE, an RRC state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the UE, or one or more conditions for relaxing a layer 1 measurement or a layer 3 measurement. In some aspects, the base station 604 may include the one or more priority rules in the configuration information 606.

At 1204, the base station transmits at least one of a first type of SSB periodically to a first group of UEs, a second type of SSB periodically within a time window to a second group of UEs, or both the first type of SSB and the second type of SSB.

For example, with reference to FIG. 6, the base station 604 may transmit at least one of the first type of SSB 608 periodically to a first group of UEs, the second type of SSB 610 periodically within a time window to a second group of UEs, or both the first type of SSB 608 and the second type of SSB 610. For example, the first type of SSB 608 may be a CD-SSB and the second type of SSB 610 may be an NCD-SSB. In some aspects, the CD-SSB is constantly on and is broadcast to all UEs. In some aspects, the NCD-SSB is activated by DCI, a MAC-CE, or dedicated RRC signaling.

In some aspects, the first type of SSB and the second type of SSB are transmitted in a same bandwidth part of the UE. In one example, with reference to FIG. 4, the CD-SSB 410a and the NCD-SSB 412a may be transmitted in the first DL bandwidth part 402.

In some aspects, the first group of UEs includes one or more UEs of a first type (e.g., one or more regular UEs), and wherein the second group of UEs includes one or more UEs of a second type (one or more low-tier UEs), wherein the one or more UEs of the second type have reduced capabilities relative to the one or more UEs of the first type.

In some aspects, a first transmit power of the first type of SSB is different from a second transmit power of the second type of SSB. In some aspects, a first SSB symbol repetition pattern of the first type of SSB is different from a second SSB symbol repetition pattern of the second type of SSB. In some aspects, a first SSB to network access occasion association pattern (e.g., a first SSB-to-RO association pattern) of the first type of SSB is different from a second SSB to network access occasion association pattern (e.g., a second SSB-to-RO association pattern) of the second type of SSB, and wherein a first SSB to network access occasion association periodicity of the first type of SSB is different from a second SSB to network access occasion association periodicity of the second type of SSB.

Finally, at 1206, the base station receives a message associated with an operation of a UE based on a measurement of at least one of the first type of SSB, the second type of SSB, or a combination thereof.

In some aspects, the message includes a measurement report containing a difference between a first signal strength of the first type of SSB and a second signal strength of the second type of SSB. For example, the operation of the UE may a differential reference signal received power reporting operation. The UE 602 may perform the differential reference signal received power reporting operation by determining a difference between a first signal strength of the first type of SSB 608 and a second signal strength of the second type of SSB 610. The UE 602 may transmit the first message 616 including a measurement report containing the difference between the first signal strength of the first type of SSB 608 and the second signal strength of the second type of SSB 610.

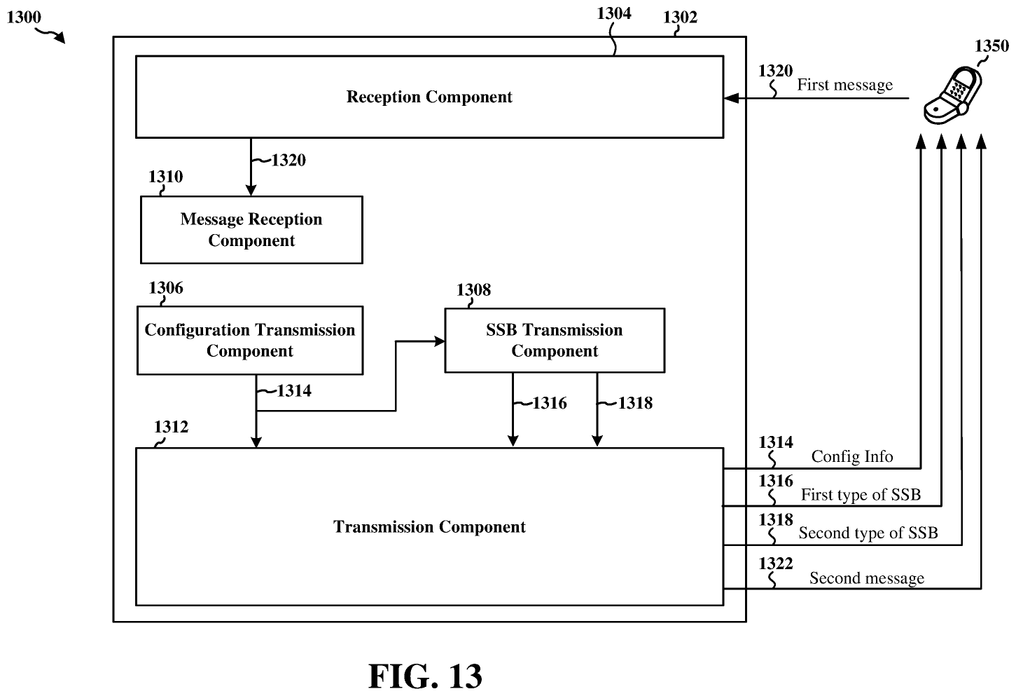

FIG. 13 is a conceptual data flow diagram 1300 illustrating the data flow between different means/components in an example apparatus 1302. The apparatus may be a base station.

The apparatus includes a reception component 1304 that receives uplink (UL) transmissions from the UE 1350. The apparatus further includes a configuration transmission component 1306 that transmits (e.g., via the transmission component 1312) a configuration of the operation indicating to use the first type of SSB 1316, the second type of SSB 1318, or both the first type of SSB 1316 and the second type of SSB 1318 for the operation. The configuration of the operation may be included in the configuration information 1314 transmitted to the UE 1350.

The apparatus further includes an SSB transmission component 1308 that receives the configuration information 1314 and transmits at least one of the first type of SSB 1316 periodically to a first group of UEs, the second type of SSB 1318 periodically within a time window to a second group of UEs, or both the first type of SSB 1316 and the second type of SSB 1318.

The apparatus further includes a message reception component 1310 that receives a message, such as the first message 1320, associated with an operation of the UE 1350 based on a measurement of at least one of the first type of SSB 1316, the second type of SSB 1318, or a combination thereof.

The apparatus further includes a transmission component 1312 that transmits downlink (DL) transmissions to the UE 1350. The transmission component 1312 may transmit a second message 1322 including RRC information based on the first message 1320 (e.g., RRC information containing one or more TCI states).

The apparatus may include additional components that perform each of the blocks of the algorithm in the aforementioned flowcharts of FIGS. 11 and 12. As such, each block in the aforementioned flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

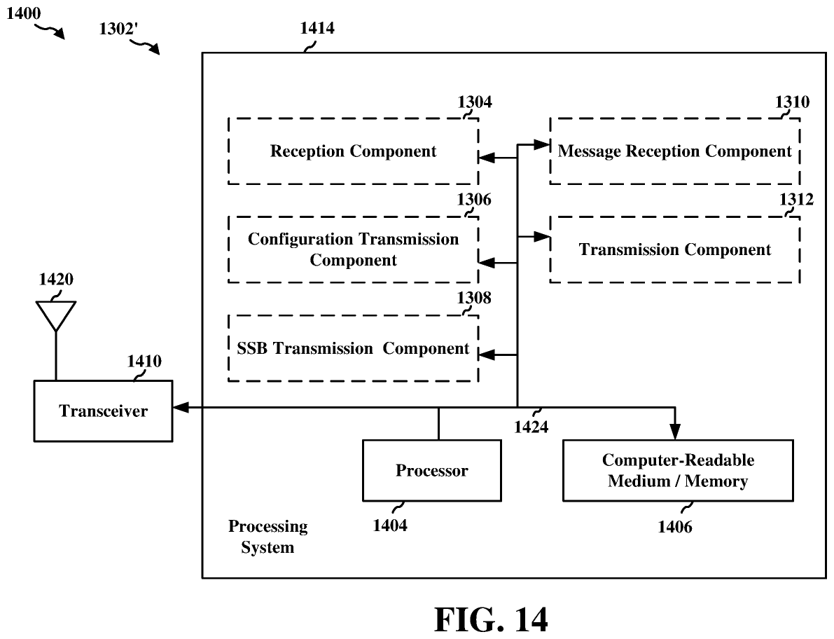

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware components, represented by the processor 1404, the components 1304, 1306, 1308, 1310, 1312 and the computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1312, and based on the received information, generates a signal to be applied to the one or more antennas 1420. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system 1414 further includes at least one of the components 1304, 1306, 1308, 1310, 1312. The components may be software components running in the processor 1404, resident/stored in the computer readable medium/memory 1406, one or more hardware components coupled to the processor 1404, or some combination thereof. The processing system 1414 may be a component of the base station 310 and may include the memory 376 and/or at least one of the TX processor 316, the RX processor 370, and the controller/processor 375. Alternatively, the processing system 1414 may be the entire base station (e.g., see 310 of FIG. 3).

In one configuration, the apparatus 1302/1302′ for wireless communication includes means for transmitting at least one of a first type of SSB periodically to a first group of UEs, a second type of SSB periodically within a time window to a second group of UEs, or both the first type of SSB and the second type of SSB, means for receiving a message associated with an operation of a UE based on a measurement of at least one of the first type of SSB, the second type of SSB, or a combination thereof, and means for transmitting a configuration of the operation indicating to use the first type of SSB, the second type of SSB, or both the first type of SSB and the second type of SSB for the operation. The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

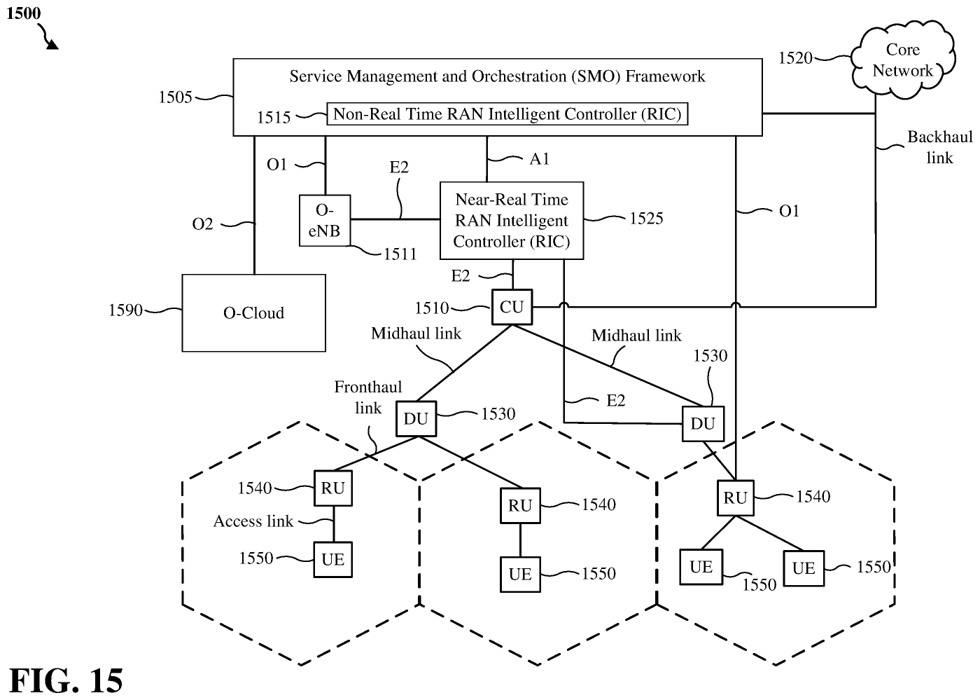

FIG. 15 shows a diagram illustrating an example disaggregated base station 1500 architecture. The disaggregated base station 1500 architecture may include one or more central units (CUs) 1510 that can communicate directly with a core network 1520 via a backhaul link, or indirectly with the core network 1520 through one or more disaggregated base station units (such as a Near-Real Time (Near-RT) RAN Intelligent Controller (RIC) 1525 via an E2 link, or a Non-Real Time (Non-RT) RIC 1515 associated with a Service Management and Orchestration (SMO) Framework 1505, or both). A CU 1510 may communicate with one or more distributed units (DUs) 1530 via respective midhaul links, such as an F1 interface. The DUs 1530 may communicate with one or more radio units (RUs) 1540 via respective fronthaul links. The RUs 1540 may communicate with respective UEs 1550 via one or more radio frequency (RF) access links. In some implementations, the UE 1550 may be simultaneously served by multiple RUs 1540.

Each of the units, i.e., the CUs 1510, the DUs 1530, the RUs 1540, as well as the Near-RT RICs 1525, the Non-RT RICs 1515 and the SMO Framework 1505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1510 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1510. The CU 1510 may be configured to handle user plane functionality (i.e., Central Unit-User Plane (CU-UP)), control plane functionality (i.e., Central Unit-Control Plane (CU-CP)), or a combination thereof. In some implementations, the CU 1510 can be logically split into one or more CU-UP units and one or more CU-CP units. The CU-UP unit can communicate bidirectionally with the CU-CP unit via an interface, such as the E1 interface when implemented in an O-RAN configuration. The CU 1510 can be implemented to communicate with the DU 1530, as necessary, for network control and signaling.

The DU 1530 may correspond to a logical unit that includes one or more base station functions to control the operation of one or more RUs 1540. In some aspects, the DU 1530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1530 may further host one or more low PHY layers. Each layer (or module) can be implemented with an interface configured to communicate signals with other layers (and modules) hosted by the DU 1530, or with the control functions hosted by the CU 1510.

Lower-layer functionality can be implemented by one or more RUs 1540. In some deployments, an RU 1540, controlled by a DU 1530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1540 can be implemented to handle over the air (OTA) communication with one or more UEs 1550. In some implementations, real-time and non-real-time aspects of control and user plane communication with the RU(s) 1540 can be controlled by the corresponding DU 1530. In some scenarios, this configuration can enable the DU(s) 1530 and the CU 1510 to be implemented in a cloud-based RAN architecture, such as a vRAN architecture.

The SMO Framework 1505 may be configured to support RAN deployment and provisioning of non-virtualized and virtualized network elements. For non-virtualized network elements, the SMO Framework 1505 may be configured to support the deployment of dedicated physical resources for RAN coverage requirements which may be managed via an operations and maintenance interface (such as an O1 interface). For virtualized network elements, the SMO Framework 1505 may be configured to interact with a cloud computing platform (such as an open cloud (O-Cloud) 1590) to perform network element life cycle management (such as to instantiate virtualized network elements) via a cloud computing platform interface (such as an O2 interface). Such virtualized network elements can include, but are not limited to, CUs 1510, DUs 1530, RUs 1540 and Near-RT RICs 1525. In some implementations, the SMO Framework 1505 can communicate with a hardware aspect of a 4G RAN, such as an open eNB (O-eNB) 1511, via an O1 interface. Additionally, in some implementations, the SMO Framework 1505 can communicate directly with one or more RUs 1540 via an O1 interface. The SMO Framework 1505 also may include a Non-RT RIC 1515 configured to support functionality of the SMO Framework 1505.

The Non-RT RIC 1515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1525. The Non-RT RIC 1515 may be coupled to or communicate with (such as via an A1 interface) the Near-RT RIC 1525. The Near-RT RIC 1525 may be configured to include a logical function that enables near-real-time control and optimization of RAN elements and resources via data collection and actions over an interface (such as via an E2 interface) connecting one or more CUs 1510, one or more DUs 1530, or both, as well as an O-eNB, with the Near-RT RIC 1525.

In some implementations, to generate AI/ML models to be deployed in the Near-RT RIC 1525, the Non-RT MC 1515 may receive parameters or external enrichment information from external servers. Such information may be utilized by the Near-RT RIC 1525 and may be received at the SMO Framework 1505 or the Non-RT MC 1515 from non-network data sources or from network functions. In some examples, the Non-RT MC 1515 or the Near-RT MC 1525 may be configured to tune RAN behavior or performance. For example, the Non-RT MC 1515 may monitor long-term trends and patterns for performance and employ AI/ML models to perform corrective actions through the SMO Framework 1505 (such as reconfiguration via O1) or via creation of RAN management policies (such as A1 policies).

Therefore, the aspects described herein may enable a UE (e.g., a low-tier user-UE or a regular UE) to perform measurements and operations that may be configured differently when a DL bandwidth part of the UE includes different types of reference signals (e.g., different types of SSBs, such as a CD-SSB and NCD-SSB) directed to different types of UEs. In some examples, these aspects may enable UEs having capability to receive multiple types of SSBs to perform operations using one or a combination of the multiple types of SSBs to perform the operations.

In some scenarios, the aspects described herein may expand the number and type of reference signals (e.g., SSBs) available to a UE for performing an operation, thereby improving the performance of the UE. The aspects described herein further enable the network (e.g., a base station) to control the types of reference signals (e.g., one or both of different types of SSBs) a UE is to use when performing a measurement and/or an operation associated with the measurement.

The following provides an overview of aspects of the present disclosure:

Aspect 1: An apparatus for wireless communication, comprising: a memory; and at least one processor coupled to the memory and configured to: measure at least one of a first type of synchronization signal block (SSB) that is periodically transmitted to a first group of user equipments (UEs), a second type of SSB that is periodically transmitted within a time window to a second group of UEs, or both the first type of SSB and the second type of SSB for an operation based on a configuration of the operation; and perform the operation based on a measurement of at least one of the first type of SSB, the second type of SSB, or a combination thereof.

Aspect 2: The apparatus of aspect 1, wherein the first type of SSB is a cell-defining SSB (CD-SSB) and the second type of SSB is a non-cell-defining SSB (NCD-SSB), wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

Aspect 3: The apparatus of aspect 1 or 2, wherein the operation includes a determination of a random access channel occasion, a determination of a transmission configuration indicator (TCI) state for a downlink channel, a determination of an uplink spatial relation for an uplink channel, a layer 1 reference signal received power (L1-RSRP) reporting operation, a radio link monitoring operation, a beam failure detection, a candidate beam detection, or a beam failure recovery operation.

Aspect 4: The apparatus of any of aspects 1 through 3, wherein the at least one processor is further configured to: receive the configuration of the operation, wherein the configuration of the operation indicates to use the first type of SSB, the second type of SSB, or both the first type of SSB and the second type of SSB for the operation.

Aspect 5: The apparatus of any of aspects 1 through 4, wherein the configuration of the operation is based on one or more priority rules, wherein the one or more priority rules indicates to measure at least one of the first type of SSB, the second type of SSB, or both the first type of SSB and the second type of SSB for the operation based on at least one of a duplex mode of the apparatus, a radio resource control (RRC) state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the apparatus, or one or more conditions for relaxing a layer 1 measurement or a layer 3 measurement.

Aspect 6: The apparatus of any of aspects 1 through 5, wherein the operation is a differential reference signal received power reporting operation, wherein the at least one processor is further configured to: transmit a message including a measurement report containing a difference between a first signal strength of the first type of SSB and a second signal strength of the second type of SSB.

Aspect 7: The apparatus of any of aspects 1 through 6, wherein the first type of SSB and the second type of SSB are transmitted in a same bandwidth part of the apparatus.

Aspect 8: The apparatus of any of aspects 1 through 7, wherein the first group of UEs includes one or more UEs of a first type, and wherein the second group of UEs includes one or more UEs of a second type, wherein the one or more UEs of the second type have reduced capabilities relative to the one or more UEs of the first type.

Aspect 9: The apparatus of any of aspects 1 through 8, wherein a first transmit power of the first type of SSB is different from a second transmit power of the second type of SSB.

Aspect 10: The apparatus of any of aspects 1 through 9, wherein a first SSB symbol repetition pattern of the first type of SSB is different from a second SSB symbol repetition pattern of the second type of SSB.

Aspect 11: The apparatus of any of aspects 1 through 10, wherein a first SSB to network access occasion association pattern of the first type of SSB is different from a second SSB to network access occasion association pattern of the second type of SSB, and wherein a first SSB to network access occasion association periodicity of the first type of SSB is different from a second SSB to network access occasion association periodicity of the second type of SSB.

Aspect 12: An apparatus for wireless communication, comprising: a memory; and at least one processor coupled to the memory and configured to: transmit at least one of a first type of synchronization signal block (SSB) periodically to a first group of user equipments (UEs), a second type of SSB periodically within a time window to a second group of UEs, or both the first type of SSB and the second type of SSB; and receive a message associated with an operation of a UE based on a measurement of at least one of the first type of SSB, the second type of SSB, or a combination thereof.

Aspect 13: The apparatus of aspect 12, wherein the first type of SSB is a cell-defining SSB (CD-SSB) and the second type of SSB is a non-cell-defining SSB (NCD-SSB), wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

Aspect 14: The apparatus of aspect 12 or 13, wherein the at least one processor is further configured to: transmit a configuration of the operation indicating to use the first type of SSB, the second type of SSB, or both the first type of SSB and the second type of SSB for the operation.

Aspect 15: The apparatus of any of aspects 12 through 14, wherein the message includes a measurement report containing a difference between a first signal strength of the first type of SSB and a second signal strength of the second type of SSB.

Aspect 16: The apparatus of any of aspects 12 through 15, wherein the first type of SSB and the second type of SSB are transmitted in a same bandwidth part of the UE.

Aspect 17: The apparatus of any of aspects 12 through 16, wherein the first group of UEs includes one or more UEs of a first type, and wherein the second group of UEs includes one or more UEs of a second type, wherein the one or more UEs of the second type have reduced capabilities relative to the one or more UEs of the first type.

Aspect 18: The apparatus of any of aspects 12 through 17, wherein a first transmit power of the first type of SSB is different from a second transmit power of the second type of SSB.

Aspect 19: The apparatus of any of aspects 12 through 18, wherein a first SSB symbol repetition pattern of the first type of SSB is different from a second SSB symbol repetition pattern of the second type of SSB.

Aspect 20: The apparatus of any of aspects 12 through 19, wherein a first SSB to network access occasion association pattern of the first type of SSB is different from a second SSB to network access occasion association pattern of the second type of SSB, and wherein a first SSB to network access occasion association periodicity of the first type of SSB is different from a second SSB to network access occasion association periodicity of the second type of SSB.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
measure at least one of a first type of synchronization signal block (SSB) that is periodically transmitted to a first group of user equipments (UEs), a second type of SSB that is periodically transmitted within a time window to a second group of UEs, or both the first type of SSB and the second type of SSB for an operation based on a configuration of the operation; and
perform the operation based on a measurement of at least one of the first type of SSB, the second type of SSB, or a combination thereof.

2. The apparatus of claim 1, wherein the first type of SSB is a cell-defining SSB (CD-SSB) and the second type of SSB is a non-cell-defining SSB (NCD-SSB), wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

3. The apparatus of claim 1, wherein the operation includes a determination of a random access channel occasion, a determination of a transmission configuration indicator (TCI) state for a downlink channel, a determination of an uplink spatial relation for an uplink channel, a layer 1 reference signal received power (L1-RSRP) reporting operation, a radio link monitoring operation, a beam failure detection, a candidate beam detection, or a beam failure recovery operation.

4. The apparatus of claim 1, wherein the at least one processor is further configured to:
receive the configuration of the operation, wherein the configuration of the operation indicates to use the first type of SSB, the second type of SSB, or both the first type of SSB and the second type of SSB for the operation.

5. The apparatus of claim 1, wherein the configuration of the operation is based on one or more priority rules, wherein the one or more priority rules indicates to measure at least one of the first type of SSB, the second type of SSB, or both the first type of SSB and the second type of SSB for the operation based on at least one of a duplex mode of the apparatus, a radio resource control (RRC) state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the apparatus, or one or more conditions for relaxing a layer 1 measurement or a layer 3 measurement.

6. The apparatus of claim 1, wherein the operation is a differential reference signal received power reporting operation, wherein the at least one processor is further configured to:
transmit a message including a measurement report containing a difference between a first signal strength of the first type of SSB and a second signal strength of the second type of SSB.

7. The apparatus of claim 1, wherein the first type of SSB and the second type of SSB are transmitted in a same bandwidth part of the apparatus.

8. The apparatus of claim 1, wherein the first group of UEs includes one or more UEs of a first type, and wherein the second group of UEs includes one or more UEs of a second type, wherein the one or more UEs of the second type have reduced capabilities relative to the one or more UEs of the first type.

9. The apparatus of claim 1, wherein a first transmit power of the first type of SSB is different from a second transmit power of the second type of SSB.

10. The apparatus of claim 1, wherein a first SSB symbol repetition pattern of the first type of SSB is different from a second SSB symbol repetition pattern of the second type of SSB.

11. The apparatus of claim 1, wherein a first SSB to network access occasion association pattern of the first type of SSB is different from a second SSB to network access occasion association pattern of the second type of SSB, and wherein a first SSB to network access occasion association periodicity of the first type of SSB is different from a second SSB to network access occasion association periodicity of the second type of SSB.

12. A method of wireless communication for a user equipment (UE), comprising:
measuring at least one of a first type of synchronization signal block (SSB) that is periodically transmitted to a first group of UEs, a second type of SSB that is periodically transmitted within a time window to a second group of UEs, or both the first type of SSB and the second type of SSB for an operation based on a configuration of the operation; and
performing the operation based on a measurement of at least one of the first type of SSB, the second type of SSB, or a combination thereof.

13. The method of claim 12, wherein the first type of SSB is a cell-defining SSB (CD-SSB) and the second type of SSB is a non-cell-defining SSB (NCD-SSB), wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

14. The method of claim 12, wherein the operation includes a determination of a random access channel occasion, a determination of a transmission configuration indicator (TCI) state for a downlink channel, a determination of an uplink spatial relation for an uplink channel, a layer 1 reference signal received power (L1-RSRP) reporting operation, a radio link monitoring operation, a beam failure detection, a candidate beam detection, or a beam failure recovery operation.

15. The method of claim 12, further comprising:
receiving the configuration of the operation, wherein the configuration of the operation indicates to use the first type of SSB, the second type of SSB, or both the first type of SSB and the second type of SSB for the operation.

16. The method of claim 12, wherein the configuration of the operation is based on one or more priority rules, wherein the one or more priority rules indicates to measure at least one of the first type of SSB, the second type of SSB, or both the first type of SSB and the second type of SSB for the operation based on at least one of a duplex mode of the UE, a radio resource control (RRC) state, a timer configuration, a type of mobility procedure, a status of multi-connectivity with one or multiple network entities, first execution criteria used for conditional reconfiguration of the measurement, second execution criteria used for measurement reporting, a measurement gap configuration, a location measurement configuration, a paging search space configuration, a capability of the UE, or one or more conditions for relaxing a layer 1 measurement or a layer 3 measurement.

17. The method of claim 12, wherein the operation is a differential reference signal received power reporting operation, further comprising:
transmitting a message including a measurement report containing a difference between a first signal strength of the first type of SSB and a second signal strength of the second type of SSB.

18. The method of claim 12, wherein the first type of SSB and the second type of SSB are transmitted in a same bandwidth part of the UE.

19. The method of claim 12, wherein the first group of UEs includes one or more UEs of a first type, and wherein the second group of UEs includes one or more UEs of a second type, wherein the one or more UEs of the second type have reduced capabilities relative to the one or more UEs of the first type.

20. The method of claim 12, wherein a first transmit power of the first type of SSB is different from a second transmit power of the second type of SSB.

21. The method of claim 12, wherein a first SSB symbol repetition pattern of the first type of SSB is different from a second SSB symbol repetition pattern of the second type of SSB.

22. The method of claim 12, wherein a first SSB to network access occasion association pattern of the first type of SSB is different from a second SSB to network access occasion association pattern of the second type of SSB, and wherein a first SSB to network access occasion association periodicity of the first type of SSB is different from a second SSB to network access occasion association periodicity of the second type of SSB.

23. An apparatus for wireless communication, comprising:
a memory; and
at least one processor coupled to the memory and configured to:
transmit at least one of a first type of synchronization signal block (SSB) periodically to a first group of user equipments (UEs), a second type of SSB periodically within a time window to a second group of UEs, or both the first type of SSB and the second type of SSB; and
receive a message associated with an operation of a UE based on a measurement of at least one of the first type of SSB, the second type of SSB, or a combination thereof.

24. The apparatus of claim 23, wherein the first type of SSB is a cell-defining SSB (CD-SSB) and the second type of SSB is a non-cell-defining SSB (NCD-SSB), wherein the CD-SSB is constantly on and is broadcast to all UEs, and wherein the NCD-SSB is activated by downlink control information (DCI), a medium access control (MAC)-control entity (CE), or dedicated radio resource control (RRC) signaling.

25. The apparatus of claim 23, wherein the at least one processor is further configured to:
transmit a configuration of the operation indicating to use the first type of SSB, the second type of SSB, or both the first type of SSB and the second type of SSB for the operation.

26. The apparatus of claim 23, wherein the message includes a measurement report containing a difference between a first signal strength of the first type of SSB and a second signal strength of the second type of SSB.

27. The apparatus of claim 23, wherein the first type of SSB and the second type of SSB are transmitted in a same bandwidth part of the UE.

28. The apparatus of claim 23, wherein the first group of UEs includes one or more UEs of a first type, and wherein the second group of UEs includes one or more UEs of a second type, wherein the one or more UEs of the second type have reduced capabilities relative to the one or more UEs of the first type.

29. The apparatus of claim 23, wherein a first transmit power of the first type of SSB is different from a second transmit power of the second type of SSB.

30. The apparatus of claim 23, wherein a first SSB symbol repetition pattern of the first type of SSB is different from a second SSB symbol repetition pattern of the second type of SSB.
